(19) United States
(12) Patent Application Publication
(10) Pub. No.: US 2012/0102432 A1
(43) Pub. Date: Apr. 26, 2012

(54) COMMUNICATING SECONDARY SELECTION FEEDBACK

(75) Inventors: Ilse M. Breedvelt-Schouten, Manotick (CA); Susan C. McIntyre, Ottawa (CA)

(73) Assignee: International Business Machines Corporation, Armonk, NY (US)

(21) Appl. No.: 13/185,089

(22) Filed: Jul. 18, 2011

(30) Foreign Application Priority Data
Oct. 25, 2010 (CA) 2718360

(51) Int. Cl. G06F 3/048

(52) U.S. Cl. 715/823

(57) ABSTRACT

An illustrative embodiment of a computer-implemented process for communicating secondary selection feedback using a potential action receives a selection of a single data point to form a selected single data point, renders a first highlight using the selected data point to create a first rendered portion, identifies and generates an available data structure associated with the selected data point, displays the first rendered portion, combines a type of action with the available data structure to form a combination, renders a second highlight using the combination to create a second rendered portion and displays rendered portions.

### BACKGROUND

1. Technical Field

This disclosure relates generally to user interfaces in a data processing system.

2. Description of the Related Art

Within business intelligence and business performance applications using data constructs from different data sources including data warehouses, spreadsheets, and other tabular and cube data, there are different ways to display and interact with the data. Known displays techniques include tables, lists and many types of charts.

Depending on how the data is structured and authored, actions can apply to different parts of data constructs. Users typically do not know in advance, just by looking at a data display, what associations exist among data elements, and how actions are applied to the data elements. For example, when a user selects a cell/data point in a table, list or chart and then takes an action including delete, filter, drill down, sort, and format which data is affected by the action is not always clear, because affects may vary depending on the action taken.

With reference to FIG. 3, a set of unidirectional synchronous instructions examples is represented. Examples 300 provide a representative sample of current scenarios depicting unidirectional synchronous instructions to other objects and actions.

Object 302 is selected in a drawing program. The program is designed to employ a technique to highlight related menu items while fading other menu items. When object 302, a rectangle is selected, hardly any toolbar items are highlighted. When selecting text of text object 304, text toolbar items 306 are highlighted.

In another user interface technique selection of a breadcrumb 308, publications in the example, causes highlighting of related objects 310. In another pair of examples 312 and 314, a user selects an object and a properties pane is updated to reflect the selection. In a further example, typical of word processing products such as Microsoft®¹ Office 2007, a user first selects text within a document with a heading 1 attribute as in example 316. The user then hovers over heading 2, shown in example 318, causing selected text to be previewed with heading 2 attributes. Highlighting for the preview of example 318 differs from that of example 316. The application example illustrates a preview function when the user hovers the mouse cursor over an action on the application “ribbon”. The application does not apply this principle to varying data constructs, only to distinct user interface objects. The knowledge of the underlying business data is not taken into account. ¹ Microsoft is a registered trademark of Microsoft Corporation in the United States and/or other countries.

With reference to FIG. 4, a tabular representation of a set of unidirectional synchronous instructions examples is represented. Sequence 400 is another example of unidirectional synchronous instructions to other objects and actions. For example, during sequence 400, a user selects a column heading in a crosstab table with a data construct of individual items 2005, 2006, 2007, total as shown in row 402 and the selection is rendered in data table 404. The user further selects cell 406 containing 2006 and selects a delete action. The delete action will remove the item 2006 in cell 406 and associated column of values 225, 275 and 230. A result of the delete action on cell 406 is shown in table 408, in which a column having a header item with a value 2006 is no longer present.

However in another scenario when the user selects that same cell 406 having a value 2006 and selects a sort by label action instead of the delete action, the sort action would apply to the labels across the header comprising values of 2005, 2006 and 2007. A result of the sort action is shown in table 410.

A known alternative to performing actions with varying results requires a user to select specific data within scope for a certain action. The requirement implies the user has to completely understand what data selection is needed for a respective action before taking that action. Typical data manipulation products, for example Microsoft Excel®², implement this requirement. For example, when using Microsoft Excel and the user takes an action without making a correct data selection in advance, the user is presented with a warning message shown as message 412. Message 412 is an example of a warning message shown by Microsoft Excel when action is not supported by the underlying data selected. ² Excel is a registered trademark of Microsoft Corporation in the United States and/or other countries.

Some business applications provide a context of primary and secondary selection feedback. Primary selection applies to a selected cell, while secondary selection applies to a pre-defined area that could include, for example, other members of a set of related data. The problem for a user is that the secondary selection may not reflect the true scope of available actions.

In another example, when a user is working with a data construct that has related items, such as members of a set shown in row 414, the interaction differs. Some business applications solve the issue of identifying where actions apply with a technique of a primary selection and a secondary selection rendering.

Data table 416 provides an example of typical presentation of a primary selection and a secondary selection. In the example, using members of a set shown in row 414 of data table 416, cell 418 containing value 2006 is a primary selection indicated by a highlighted border. A secondary selection is also indicated using a different style of highlighting from the highlighting of the primary selection. In this example, the values 2005, 2006, 2007, and Total column headings of row 420 are all members of a set of related data as shown in data table 416.

When a user invokes delete the delete operation will discard all years having values of 2005, 2006, 2007 and an associated total, as shown in data table 422. The discard result 424, an empty space, is expected based on the secondary selection feedback.

However, when the user invokes a calculate operation the operation will use column 418 having a value of 2006 in data table 416 as basis for the calculation of increasing each value by 100, and the secondary selection feedback shown in 416 does not reflect the action to create column 428 in data table 426.

A limitation of each approach in the examples provided is that a scope of each action requires another selection, whether an explicit selection or a secondary selection, and the further selection must be remembered by a user in advance of taking an action. Requiring a user to remember a further selection in advance assumes the user knows the underlying data construct. The requirement adds a mental burden and reduces efficiency when working with business intelligence data.

### BRIEF SUMMARY

According to one embodiment, a computer-implemented process for communicating secondary selection feedback using a potential action receives a selection of a single data point to form a selected single data point, renders a first highlight using the selected data point to create a first rendered portion, identifies and generates an available data structure associated with the selected data point, displays the first rendered portion to a user, combines a type of action with the available data structure to form a combination, renders a second highlight using the combination to create a second rendered portion and displays rendered portions to the user.

According to another embodiment, a computer program product for communicating secondary selection feedback using a potential action comprises a computer recordable-type media containing computer executable program code stored thereon. The computer executable program code comprises computer executable program code for receiving a selection of a single data point to form a selected single data point, computer executable program code for rendering a first highlight using the selected data point to create a first rendered portion, computer executable program code for identifying and generating an available data structure associated with the selected data point, computer executable program code for displaying the first rendered portion to a user, computer executable program code for combining a type of action with the available data structure to form a combination, computer executable program code for rendering a second highlight using the combination to create a second rendered portion and computer executable program code for displaying rendered portions to the user.

According to another embodiment, an apparatus for communicating secondary selection feedback using a potential action comprises a communications fabric, a memory connected to the communications fabric, wherein the memory contains computer executable program code, a communications unit connected to the communications fabric, an input/output unit connected to the communications fabric, a display connected to the communications fabric and a processor unit connected to the communications fabric. The processor unit executes the computer executable program code to direct the apparatus to receive a selection of a single data point to form a selected single data point, render a first highlight using the selected data point to create a first rendered portion, identify and generating an available data structure associated with the selected data point, display the first rendered portion to a user, combine a type of action with the available data structure to form a combination, render a second highlight using the combination to create a second rendered portion and display rendered portions to the user.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system operable for various embodiments of the disclosure;

FIG. 2; is a block diagram of a system for communicating secondary selection feedback using a potential action, in accordance with various embodiments of the disclosure;

FIG. 3 is a pictorial representation of a set of unidirectional synchronous instructions examples;

FIG. 4 is a tabular representation of a set of unidirectional synchronous instructions examples;

FIG. 5 is a process of communicating secondary selection feedback on an action in accordance with various embodiments of the disclosure;

FIG. 6 is a block diagram of a portion of operations in the process of FIG. 5, in accordance with one embodiment of the disclosure;

FIG. 7 is a block diagram of a portion of operations in the process of FIG. 5, in accordance with one embodiment of the disclosure;

FIG. 8 is a block diagram of a portion of operations in the process of FIG. 5, in accordance with one embodiment of the disclosure;

FIG. 9 is a tabular representation of two data visualizations based on a same data structure and using the process of FIG. 5, in accordance with one embodiment of the disclosure;

FIG. 10 is a tabular representation of two data visualizations based on a same data structure with sets indicated and using the process of FIG. 5, in accordance with one embodiment of the disclosure;

FIG. 11 is a tabular representation of a data point selection using two data visualizations based on a same data structure and the process of FIG. 5, in accordance with one embodiment of the disclosure;

FIG. 12 is a tabular representation of hovering over a Delete action illustrating affected data by the action and using the process of FIG. 5, in accordance with one embodiment of the disclosure;

FIG. 13 is a tabular representation of hovering over a Drill down action illustrating affected data by the action and using the process of FIG. 5, in accordance with one embodiment of the disclosure;

FIG. 14 is a tabular representation of hovering over a Sort by Label action illustrating affected data by the action and using the process of FIG. 5, in accordance with one embodiment of the disclosure;

FIG. 15 is a tabular representation of hovering over a Filter-exclude action illustrating affected data by the action and using the process of FIG. 5, in accordance with one embodiment of the disclosure;

FIG. 16 is a tabular representation of selecting a data point in a grid or chart using the process of FIG. 5, in accordance with one embodiment of the disclosure;

FIG. 17 is a tabular representation of hovering over a Drill down action illustrating affected data by the action using the process of FIG. 5 and data point selection of FIG. 16, in accordance with one embodiment of the disclosure;

FIG. 18 is a tabular representation of hovering over a Filter-greater than action illustrating affected data by the action using the process of FIG. 5 and data point selection of FIG. 16, in accordance with one embodiment of the disclosure;

FIG. 19 is a flowchart of a high level view of a process for communicating secondary selection feedback using a potential action, in accordance with an illustrative embodiment of the disclosure; and

FIG. 20 is a flowchart of a process for changing an action within a process for communicating secondary selection feedback using a potential action, in accordance with an illustrative embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer readable medium(s) having computer readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, or a magnetic storage device or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with the computer-readable program code embodied therein, for example, either in baseband or as part of a carrier wave. Such a propagated signal may take a variety of forms, including but not limited to electro-magnetic, optical or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer-readable medium may be transmitted using any appropriate medium, including but not limited to wireless, wire line, optical fiber cable, RF, etc. or any suitable combination of the foregoing.

Computer program code for carrying out operations for aspects of the present disclosure may be written in any combination of one or more programming languages, including an object oriented programming language such as Java™, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus, (systems), and computer program products according to embodiments of the disclosure. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

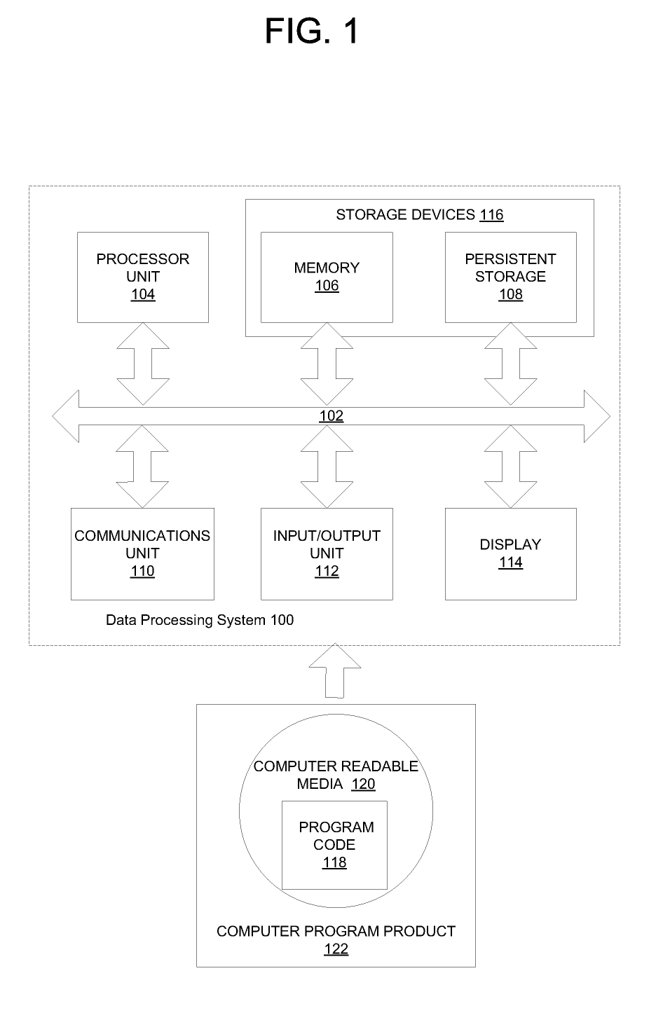

Turning now to FIG. 1 a block diagram of an exemplary data processing system operable for various embodiments of the disclosure is presented. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information, such as, for example without limitation, data, program code in functional form, and/or other suitable information either on a temporary basis and/or a permanent basis. Memory 106, in these examples, may be, for example, a random access memory or any other suitable volatile or non-volatile storage device. Persistent storage 108 may take various forms depending on the particular implementation. For example, persistent storage 108 may contain one or more components or devices. For example, persistent storage 108 may be a hard drive, a flash memory, a rewritable optical disk, a rewritable magnetic tape, or some combination of the above. The media used by persistent storage 108 also may be removable. For example, a removable hard drive may be used for persistent storage 108.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples the instructions are in a functional form on persistent storage 108. These instructions may be loaded into memory 106 for execution by processor unit 104. The processes of the different embodiments may be performed by processor unit 104 using computer-implemented instructions, which may be located in a memory, such as memory 106.

These instructions are referred to as program code, computer usable program code, or computer readable program code that may be read and executed by a processor in processor unit 104. The program code in the different embodiments may be embodied on different physical or tangible computer readable media, such as memory 106 or persistent storage 108.

Program code 118 is located in a functional form on computer readable media 120 that is selectively removable and may be loaded onto or transferred to data processing system 100 for execution by processor unit 104. Program code 118 and computer readable media 120 form computer program product 122 in these examples. In one example, computer readable media 120 may be in a tangible form, such as, for example, an optical or magnetic disc that is inserted or placed into a drive or other device that is part of persistent storage 108 for transfer onto a storage device, such as a hard drive that is part of persistent storage 108. In a tangible form, computer readable media 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable media 120 through a communications link to communications unit 110 and/or through a connection to input/output unit 112. The communications link and/or the connection may be physical or wireless in the illustrative examples. The computer readable media also may take the form of non-tangible media, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 may be any hardware apparatus that may store data. Memory 106, persistent storage 108 and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache such as found in an interface and memory controller hub that may be present in communications fabric 102.

According to an illustrative embodiment, a computer-implemented process for communicating secondary selection feedback using a potential action receives a selection of a single data point to form a selected single data point, renders a first highlight using the selected data point to create a first rendered portion, identifies and generates an available data structure associated with the selected data point, displays the first rendered portion to a user, combines a type of action with the available data structure to form a combination, renders a second highlight using the combination to create a second rendered portion and displays rendered portions to the user. Embodiments of the computer-implemented process therefore provide a more effective display of affected data from which a user may make a better decision regarding a potential action on a selected data point.

Using data processing system 100 of FIG. 1 as an example, an illustrative embodiment provides the computer-implemented process stored in memory 106, executed by processor unit 104, for communicating secondary selection feedback using a potential action receives a selection of a single data point from display 114. Processor unit 104 receives a selection of a single data point to form a selected single data point. Processor unit 104 renders a first highlight using the selected data point to create a first rendered portion. Processor unit 104 identifies and generates an available data structure associated with the selected data point in storage devices 116. Processor unit 104 displays the first rendered portion to a user using display 114. Processor unit 104 combines a type of action with the available data structure to form a combination and renders a second highlight using the combination to create a second rendered portion. Processor unit 104 displays rendered portions to the user using display 114. Data processing system 100 may be one of a set of data processing systems forming a network of data processing systems in which processing activity of the described process may occur on one or more processor units of the set.

In an alternative embodiment, program code 118 containing the computer-implemented process may be stored within computer readable media 120 as computer program product 122. In another illustrative embodiment, the process for communicating secondary selection feedback using a potential action receives a selection of a single data point may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

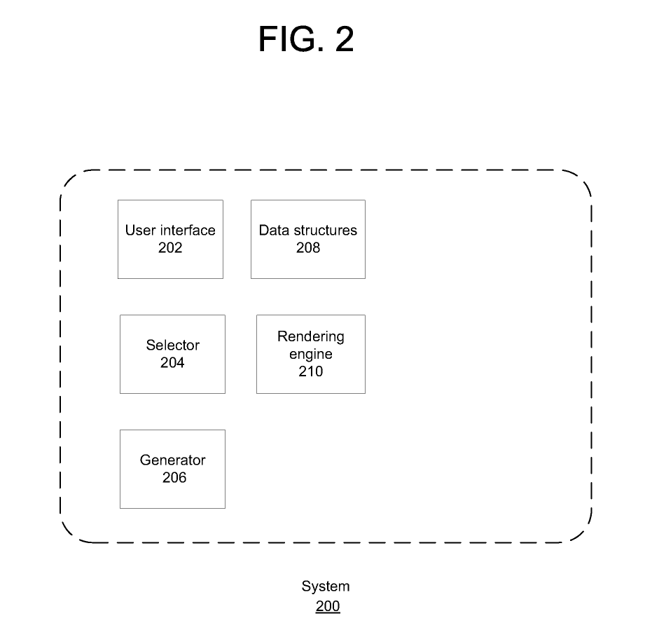

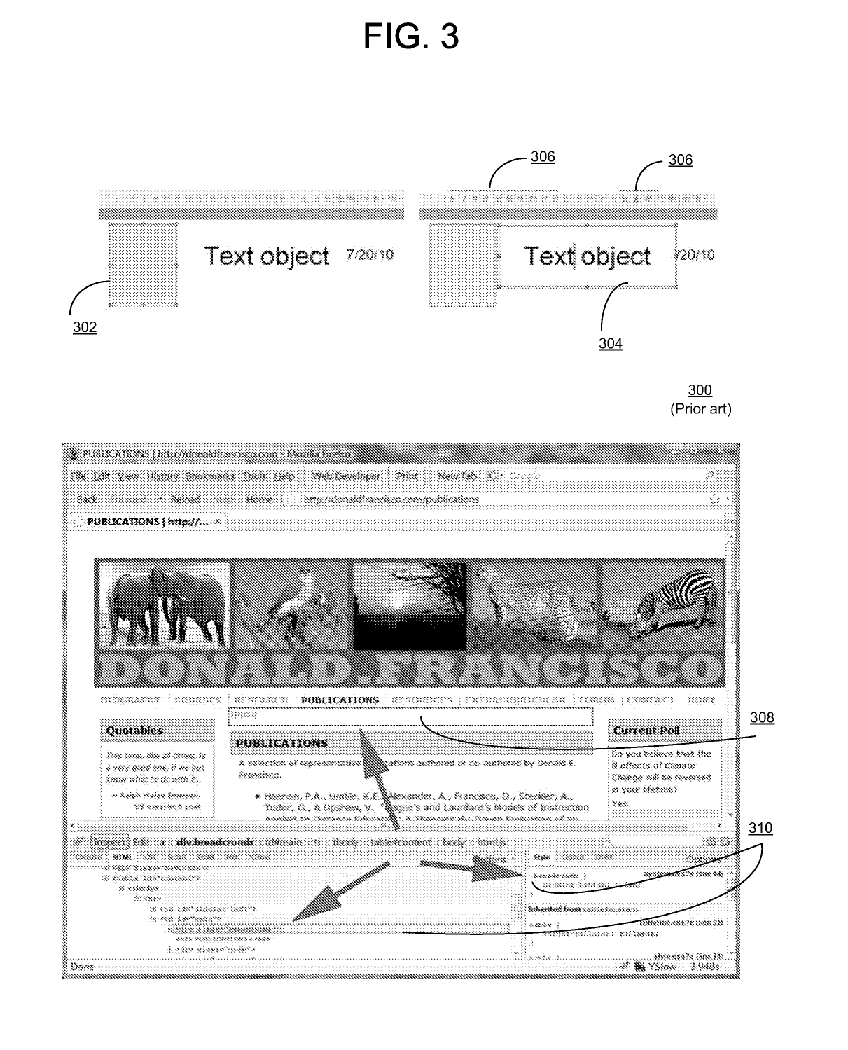

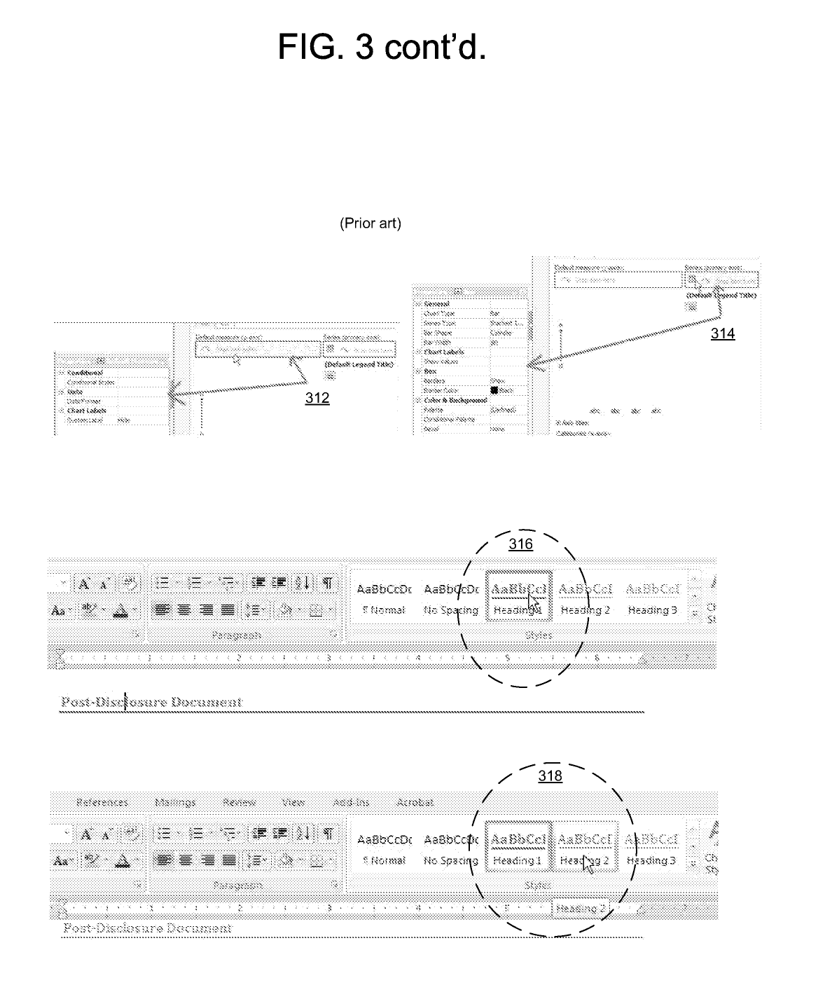

With reference to FIG. 2, a block diagram of a system for communicating secondary selection feedback using a potential action, in accordance with various embodiments of the disclosure is presented. System 200 is an example of an embodiment of components using an underlying data processing system such as data processing system 100 of FIG. 1 for communicating secondary selection feedback using a potential action.

System 200 comprises a number of interdependent components including user interface 202, selector 204, generator 206, data structures 208 and rendering engine 210. System 200 may be implemented using a set of discrete components identified as functional elements or as a composition including all functional elements in a unit without affecting the intended purpose of the disclosed process.

Using an embodiment of system 200 provides users with a capability to comprehend what actions will affect selected data without having to understand a data construct used by a business data display. The capability provides value because depending on the data source used or how the data is authored, a determination as to how the data is rendered behaves differently depending on the data constructs.

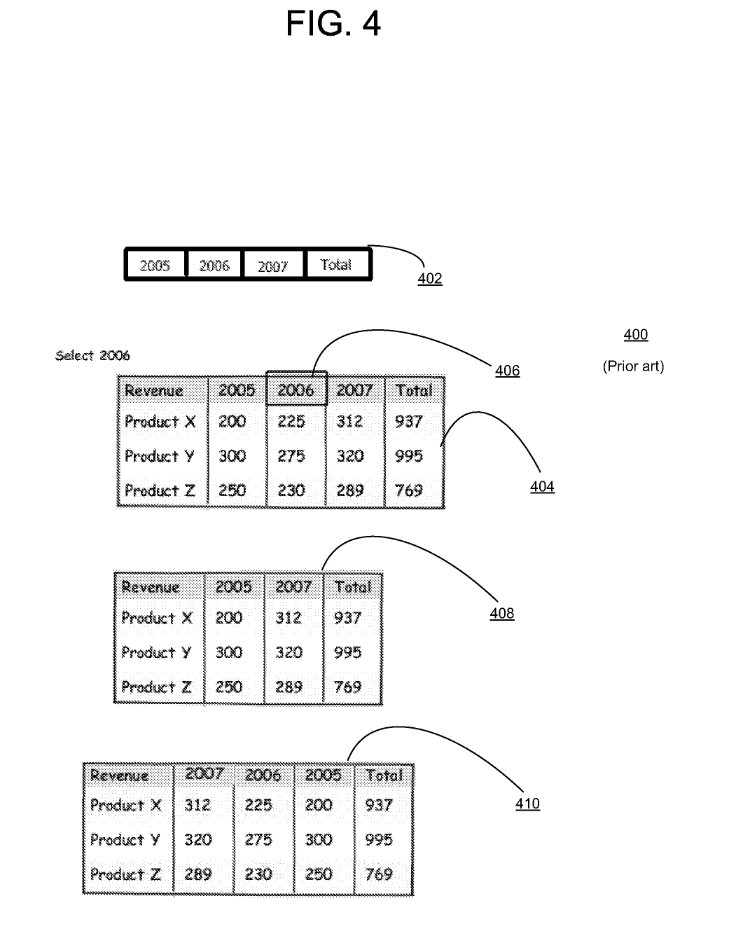

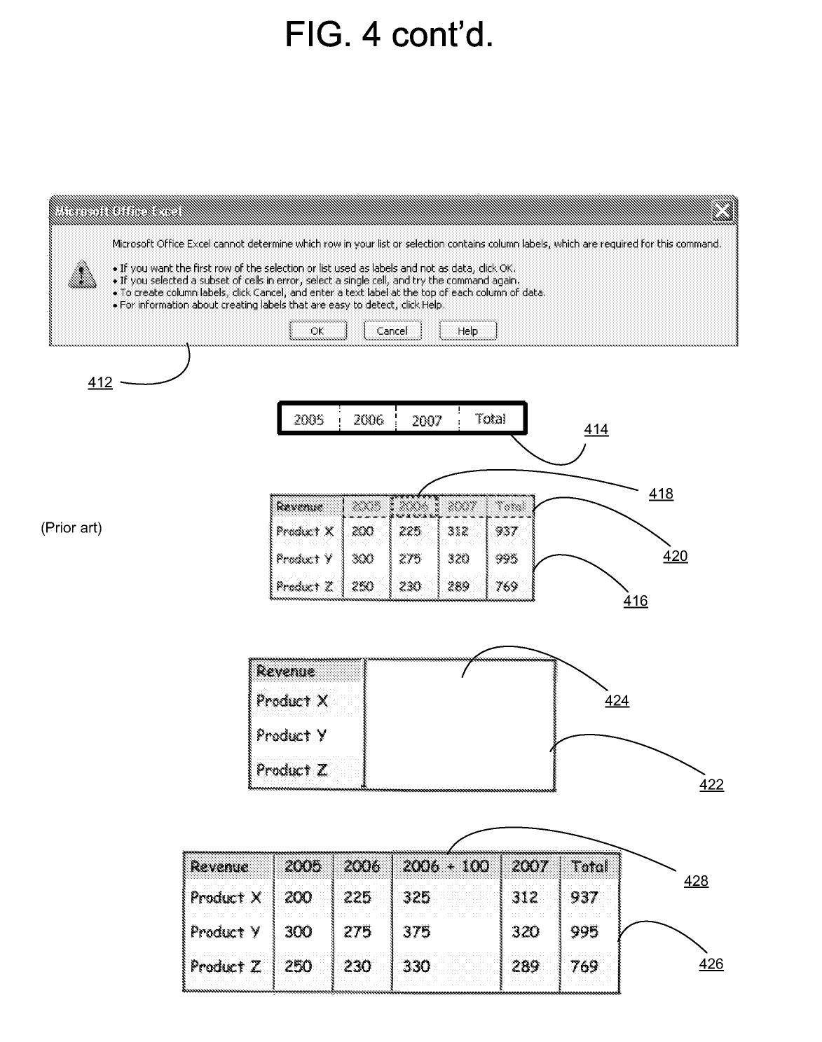

In a visualization of data, such as a grid, a user can select a cell. This cell can belong to a row, to a column, to a set of related data in a row or column, to the measure values, or to the grid as a whole. When the user selects a cell, this cell gets the primary selection feedback, for example a red outline as shown in cell 406 of FIG. 4. When the user hovers the mouse cursor over an action in a toolbar or a menu, the visualization of a secondary selection adjusts automatically to reflect the scope of the hovered action, so that users can see specific data applicable to the action. When the user selects the action on the toolbar, the appropriate secondary selection will be used in the action.

The user is aware of which data will be affected by an action before the action is taken and will not have to remember or be trained on the data scope of each action. Ease-of-use is increased and likelihood that more users will be able to work with business (intelligence) data sets is increased.

User interface 202 provides a typical interface between the system and a user of the system. User interface 202 provides a capability to display data items and to prompt a user for selections of data items or actions from a toolbar. Rendering engine 210 renders data items in user interface 202.

Selector 204 includes a notion of primary selection and secondary selection of data items. Primary selection remains the same as currently implemented, while secondary selection feedback adjusts to the scope of the potential action on the data. Rendering engine 210 provides a capability to render a primary selection and a secondary selection with different highlighting characteristics.

Generator 206 provides a capability to create data structures 208 which may be stored and maintained during operation of system 200. Data structures 208 are created in accordance with a combination of information comprising a selected data point and potential action. Data structures 208 are typically hidden from a user but may have a representation exposed in a data visualization provided on display 114 of data processing system 100 of FIG. 1. The representation varies according to the generated data structure.

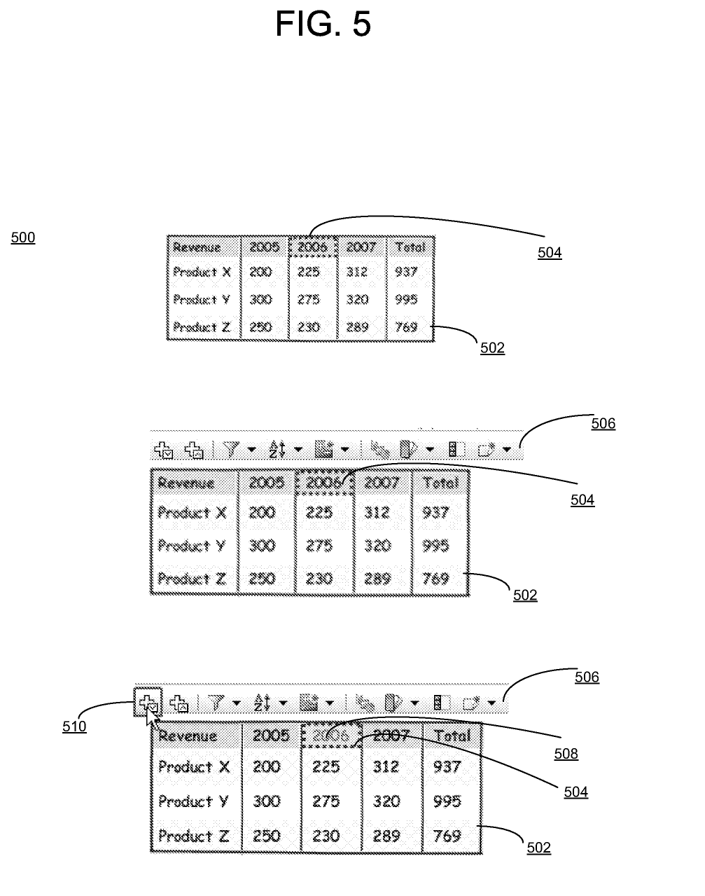

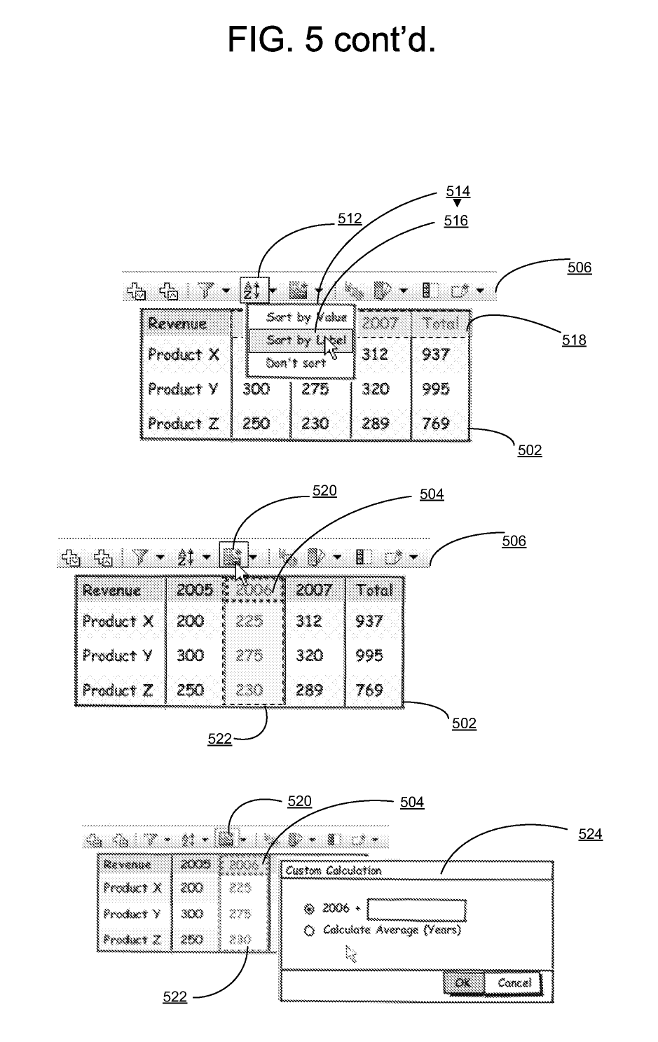

With reference to FIG. 5, a process of communicating secondary selection feedback on an action in accordance with various embodiments of the disclosure is presented. Process 500 is a set of examples illustrating a process of events using the disclosed technique. The process generally comprises three operations of selecting a data item, exploring for an action applicable to the selected data item and selecting an action with a dialog. In cases where the selected action has an associated dialog an opportunity exists to provide more secondary highlighting input on actions within the dialog to the action.

In a set of examples 500a user selects any data cell in a grid or a chart 502, such as data in cell 504. The data processing system provides feedback for the selection to indicate cell 504 is a primary selection using a form of highlighting. For example, cell 504 may have a colored border or a flashing border to distinguish the cell from other cells.

Exploring for an action, a user hovers a mouse cursor over a user interface element representing actions, for example, buttons of toolbar 506, a menu item, or context menu item. While the user hovers over an action menu item in toolbar 506 or menu, the secondary selection applicable to the action hovered over is shown on the fly.

On hovering the mouse cursor over the Drill Down action 510 in toolbar 506, cell 504 receives the secondary selection. Secondary selection is indicated by a change in highlighting 508 to appear different from the primary selection highlighting.

When the user selects action menu item 512 in toolbar 506, the secondary selection applicable to the action is shown on the fly as sort options in toolbar dropdown 514. On hovering the mouse cursor over Sort by Label action 516 in toolbar dropdown 514, all years and associated total are shown with secondary selection highlighting of row 518.

On hovering the mouse cursor over Calculate action 520, column 522 of cell 504 is shown with secondary selection highlighting. A user selects an action requiring more input using a dialog, for example, custom calculation 524, before the selected action is completed. The primary and secondary selections remain selected and displayed while the dialog is displayed. When selecting an option in the dialog affects the secondary selection, the affect will be reflected in the data visualization in the background window where the display is shown. Custom calculation 524 will be applied to all members of 2006, column 522 shown with secondary highlighting).

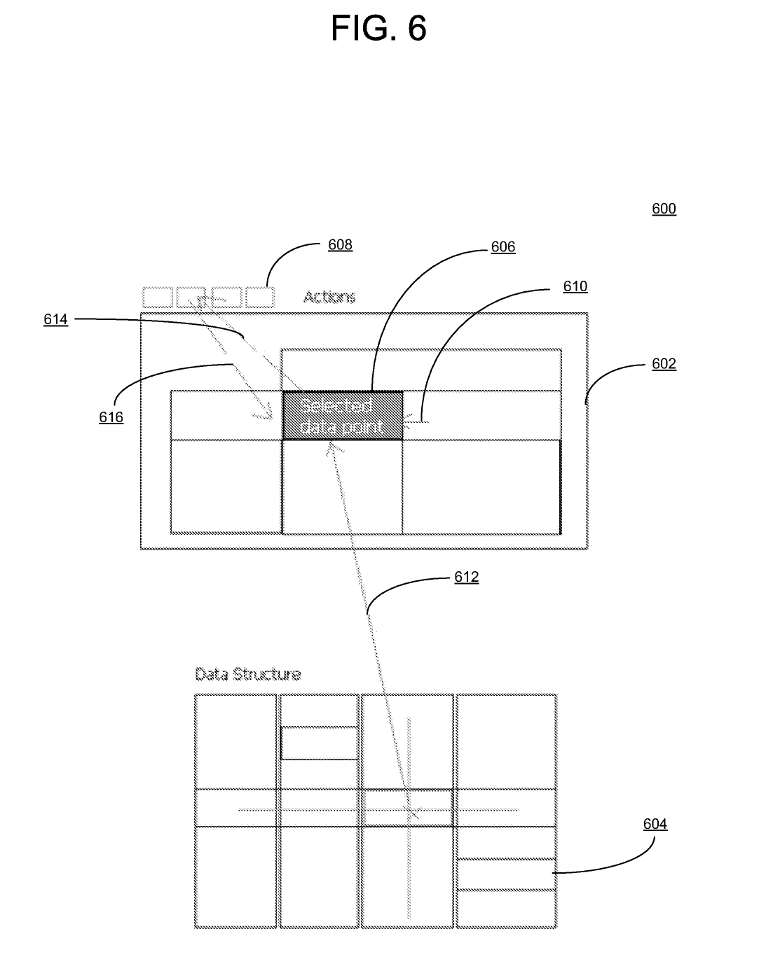

With reference to FIG. 6, a block diagram of a portion of operations in the process of FIG. 5, in accordance with one embodiment of the disclosure is presented. Process 600 is an example illustration of an initial portion of a concept of bi-directional instructions for communicating secondary selection feedback for a potential action of process 500 of FIG. 5.

Process 600 focuses on a bi-directional approach, using an underlying data construct as a basis for determining which data elements will actually be highlighted and affected by an indicated action. Process 600 begins with a user selecting single data point 606 in data display 602 in operation 610. A supporting data processing system identifies and generates the available data structures related to the selected data point 606. This information is provided to the selected data point in operation 612. The data presented in data display 602 is maintained as data structure 604. Underlying data structure 604 is not directly shown to the user and is hidden from the user. A user may further select an action from toolbar 608 containing processing options for the selected data.

While the user hovers over an action in toolbar 608 of the user interface information about the data structure is transferred to the action in operation 614. Depending on a combination of the type of action and available data structure, the system renders a highlight of the actual data elements that will be affected by the action in operation 616.

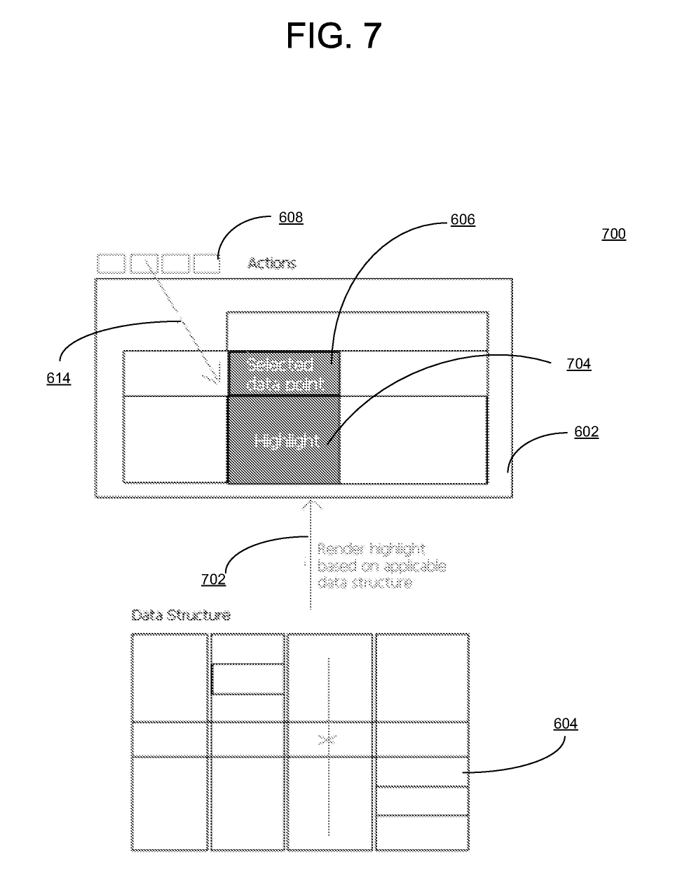

With reference to FIG. 7, a block diagram of a portion of operations in the process of FIG. 5, in accordance with one embodiment of the disclosure is presented. Process 700 is an example illustration of a further portion of a concept of bi-directional instructions for communicating secondary selection feedback for a potential action of using operations of FIG. 6.

Using rendering information created in operation 616 of FIG. 6, rendering of a highlight using an applicable data structure occurs in operation 702 to create a highlighted portion 704 of data display 602.

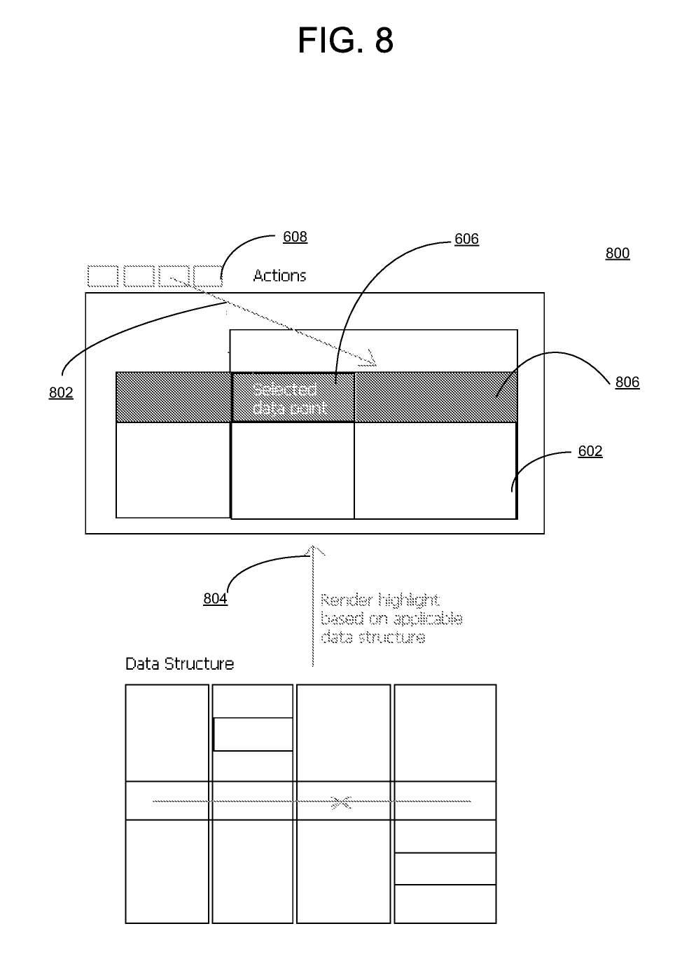

With reference to FIG. 8, a block diagram of a portion of operations in the process of FIG. 5, in accordance with one embodiment of the disclosure is presented. Process 800 is an example illustration of a further portion of a concept of bi-directional instructions for communicating secondary selection feedback for a potential action of using operations of FIG. 7.

When user hovers over another action in toolbar 608 while maintaining selected data point 606 in operation 802, the highlight shown in data display 602 will change to highlighted portion 806, based on the combination of that specific action and the applicable data structure in operation 804. The combination of a specific action and applicable data structure differs from that of FIG. 7, accordingly the highlighted portion of the display also changed. When the user invokes the action item in toolbar 608 the action will apply to a portion of data structure 604 represented by the currently highlighted portion 806 of data display 602.

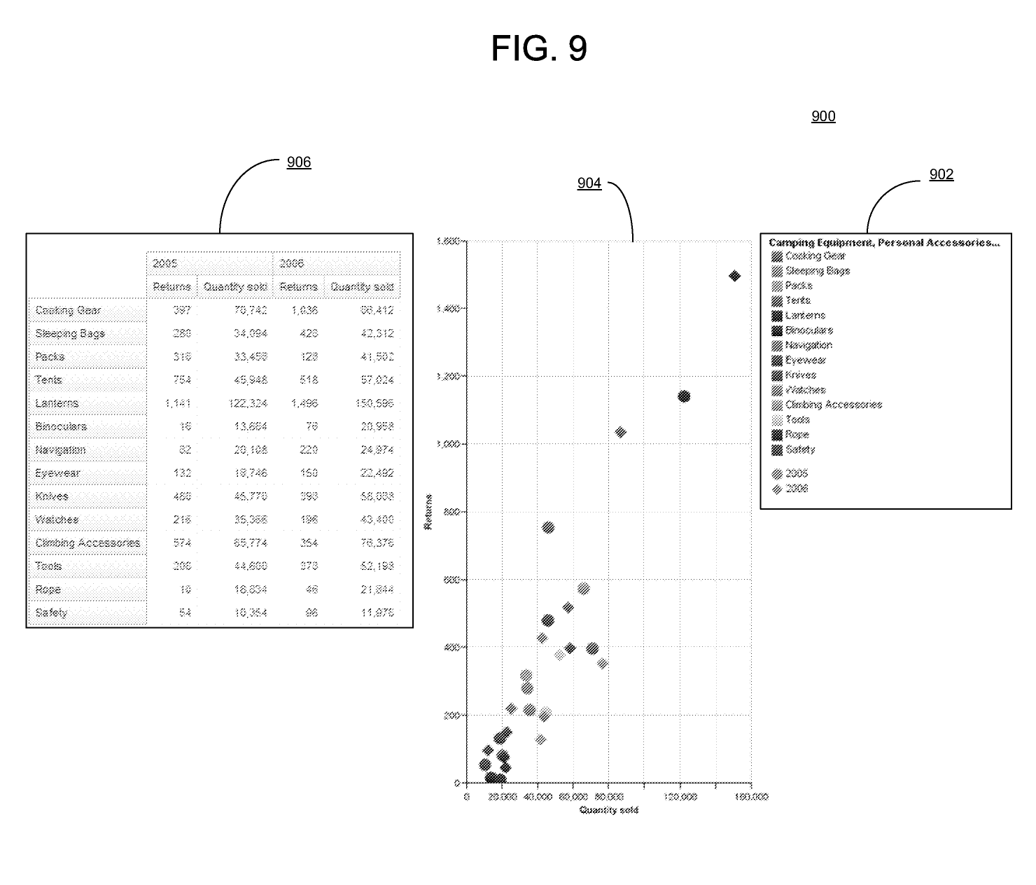

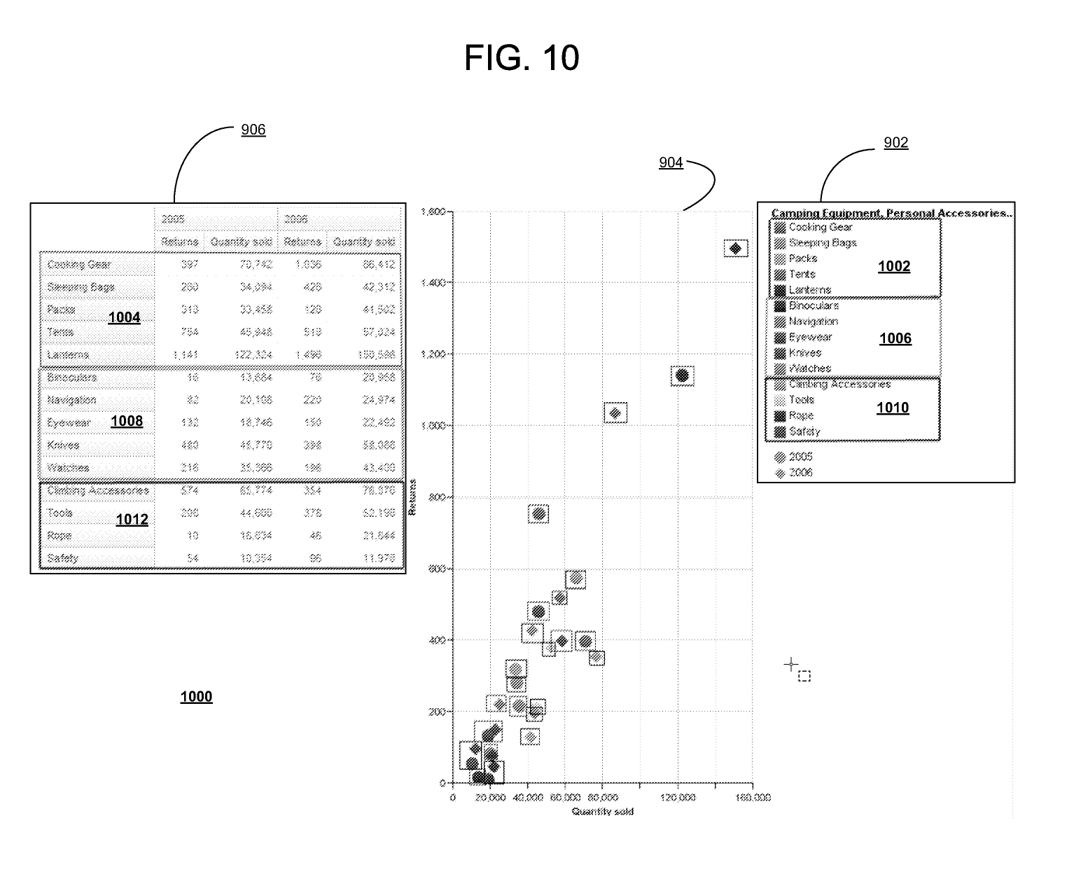

With reference to FIG. 9, a tabular representation of different data visualizations based on a same data structure and using the process of FIG. 5, in accordance with one embodiment of the disclosure is presented. The tabular representation 900 is an example of scatter plot chart 904 with associated legend 902 and data grid 906. Elements of tabular representation 900 will be used for the series of examples in FIG. 10 through FIG. 18.

Embodiments of the disclosure can be applied to multiple domains. One embodiment may be in a business intelligence and performance management domain, in which data is structured differently, depending on how the data is authored or queried. Given the tremendous growth of data visualizations within fields including computer sciences, analytics, and medical research, the importance of interacting with the data visualizations become more prevalent.

Since data visualizations can be constructed in different ways, a simple object-action model typically cannot be applied. Because underlying data structures for data visualizations can differ per author or per modeler, a user will not know the impact of applying a certain action to an initial selection. The precision of selection is often lacking causing users to see perceived unexpected behavior based on actions applied by the user. Embodiments of the disclosure assist users to understand the data structure of the visualization the users are interacting with, enabling the user to trust and predict interactions with the data.

Scatter plot chart 904 with associated legend 902 depicts data points representing product values shown in data grid 906. Each data point in scatter plot chart 904 represents an intersection of Returns and Quantity Sold for Products in the years 2005 and 2006. Legend 902 comprises entries corresponding to the product entries of data grid 906.

With reference to FIG. 10, a tabular representation of two data visualizations based on a same data structure with sets indicated and using the process of FIG. 5, in accordance with one embodiment of the disclosure is presented. Tabular representation 1000 includes data visualizations based on an underlying data structure containing data for categories of Returns and Quantity Sold for Products in the years 2005 and 2006.

Products dimension is modeled as separate sets. Data grid 906 shows the underlying data structure, indicating different data sets, set 1, set 2 and set 3 within the products. The members for set 1 including Cooking Gear, Sleeping Bags, Packs, Tents, and Lanterns are represented in legend 902 as items 1002 and data grid 1004. The members for set 2 including Binoculars, Navigation, Eyewear, Knives, and Watches are represented in legend 902 as items 1006 and data grid 1008. The members for set 3 including Climbing Accessories, Tools, Rope, and Safety are represented in legend 902 as items 1010 and data grid 1012. Data points of scatter plot chart are color coded to match the color-coding of the sets in legend 902.

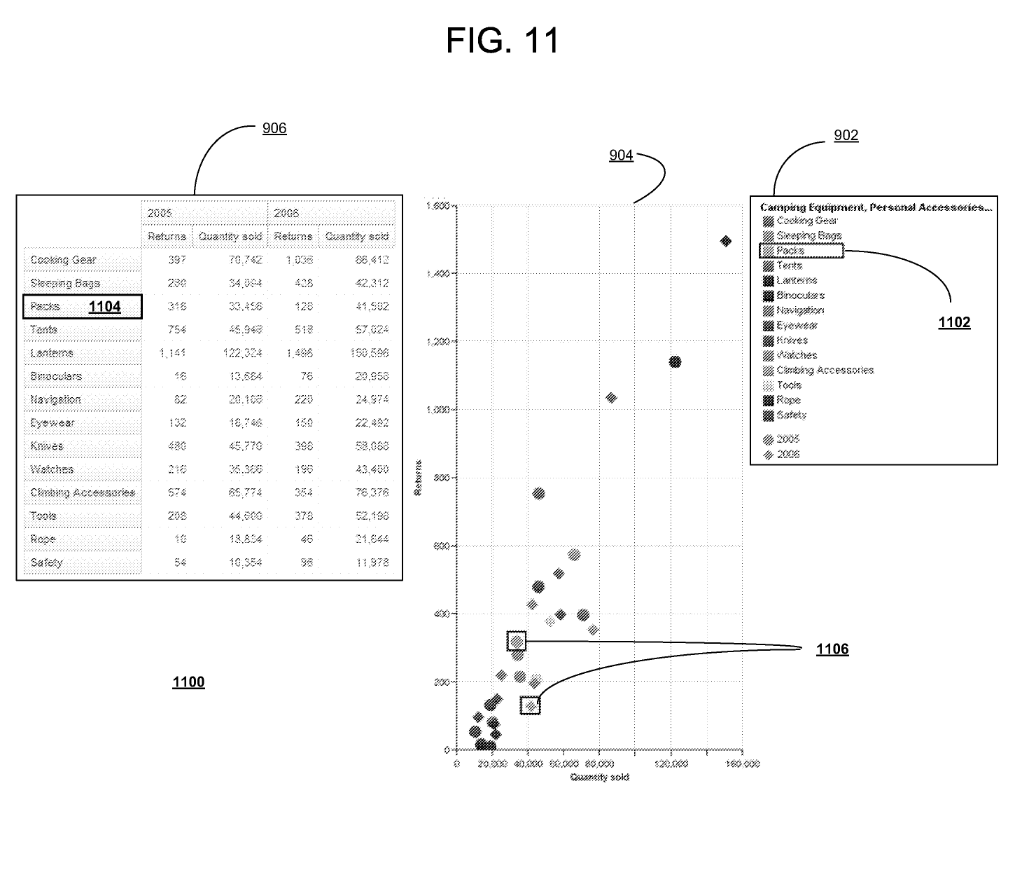

With reference to FIG. 11, a tabular representation of a data point selection using differing data visualizations based on a same data structure and the process of FIG. 5, in accordance with one embodiment of the disclosure is presented. Interaction 1100 is an example of a user selection of a data point in data grid 906 or scatter plot chart 904.

The user selection of Packs 1104 in data grid 906 or data points in scatter plot chart 904 is also highlighted as Packs 1102 in legend 902 by a thick black border. Data point selection therefore may be made using either the data grid or the scatter plot chart of the example with the same result.

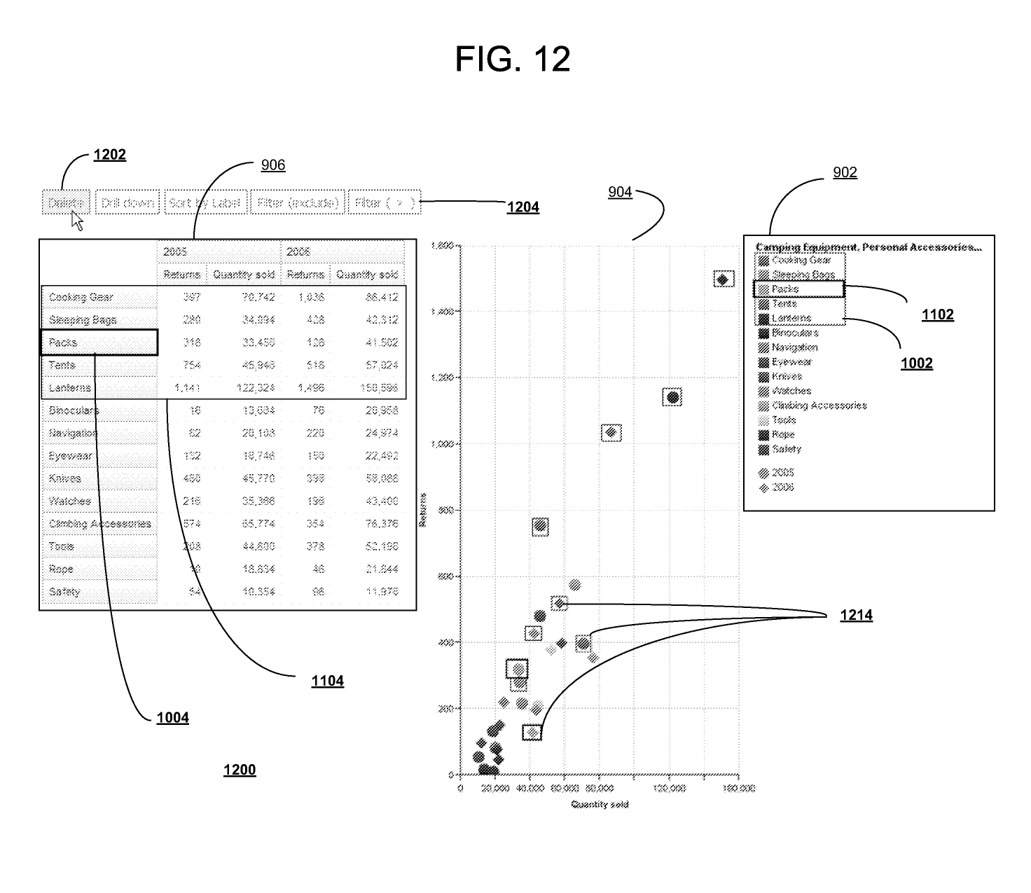

With reference to FIG. 12, a tabular representation of hovering over a delete action illustrating affected data by the action and using the process of FIG. 5, in accordance with one embodiment of the disclosure is presented. Interaction 1200 is an example of a selection of a data point of FIG. 11 with a following associated action.

After a data point selection, such as Packs 1104 of FIG. 1100, a user hovers over a Delete action 1202 in a task bar 1204 of a user interface. Interaction 1200 is an image of both the data grid and the scatter plot chart representing which data would be affected by Delete action 1202.

Hovering over Delete action 1202 changes highlighting of data elements, showing the affected data for the specific action (grid or chart). The user selection of Packs 1004 is shown within set 1 as data grid 1104 in addition to Packs 1102 of legend 902 within items 1002 as an indication of which other data would be affected by Delete action 1202. Because Packs has been modeled to be part of a larger set 1 also containing Cooking Gear, Sleeping Bags, Tents, and Lanterns, the system indicates that these elements and related data values will also be deleted. The potential impact is shown in user interface by a thinner black border around the data items of set 1 that would be affected by Delete action 1202. In scatter plot chart 904, a thin black line 1002 of legend 902 shows the impact of the user selection and the related Pack data in the scatter plot chart is highlighted as shown using some of the affected data as data points 1214. When hovering over Delete action 1202, thin black borders indicate data elements also affected by Delete action 1202 whereas the user selection items were highlighted in thick black lines.

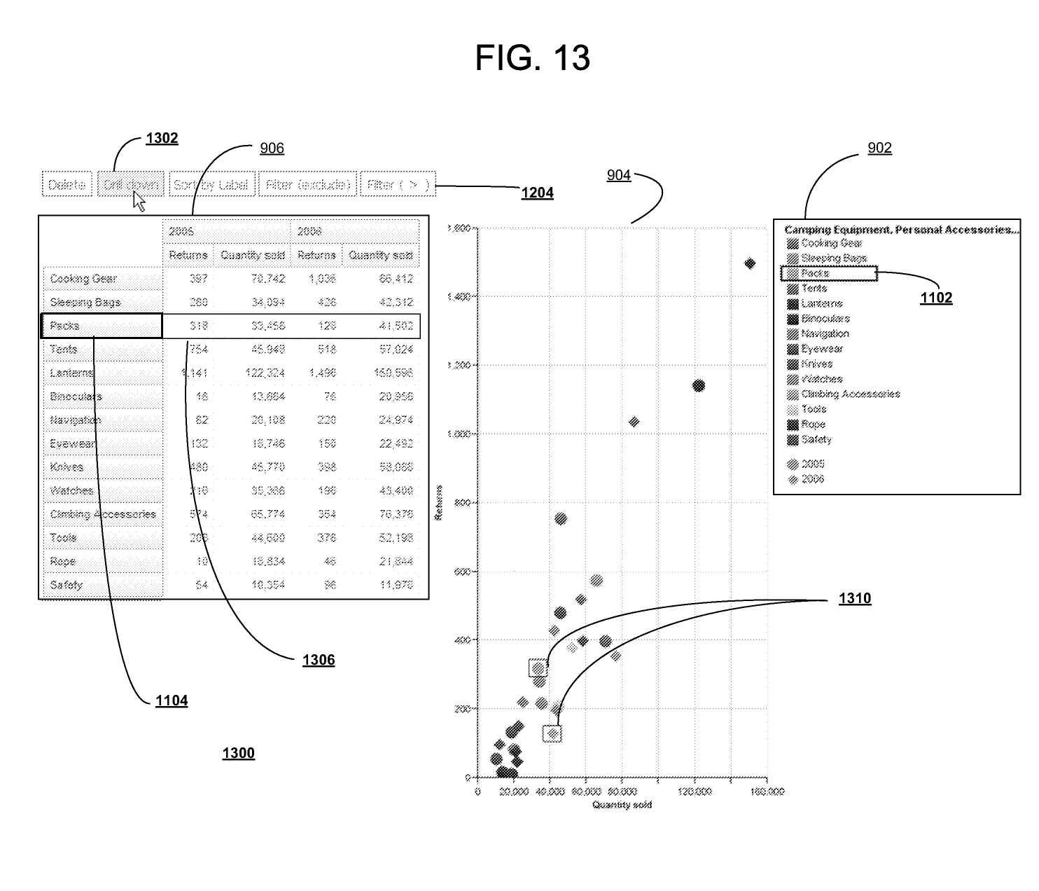

With reference to FIG. 13, a tabular representation of hovering over a Drilldown action illustrating affected data by the action and using the process of FIG. 5, in accordance with one embodiment of the disclosure is presented. Interaction 1300 is an example of a selection of a data point of FIG. 11 with a following associated action.

Continuing the previous example, a user then hovers over Drill down action 1302 of tool bar 1204. Previously selected item Packs 1104 is highlighted in data grid 906 as well as Packs 1102 of legend 902 of scatter plot chart 904. Packs 1104 in data grid 906 has affected data 1306, which would be affected by Drill down action 1302. In addition scatter plot chart 904 contains data points 1310 representing affected data items as a result of hovering over Drill down action 1302.

Using the same data in the previous examples, highlighting in the data grid and chart respectively changes according to a potential action selection. The interaction between the user selection and possible subsequent action using the underlying data structure causes the representation presented to the user in the user interface to change. The representation informs the user of possible results without the user having to know the underlying data structure and therefore make a more informed choice of action.

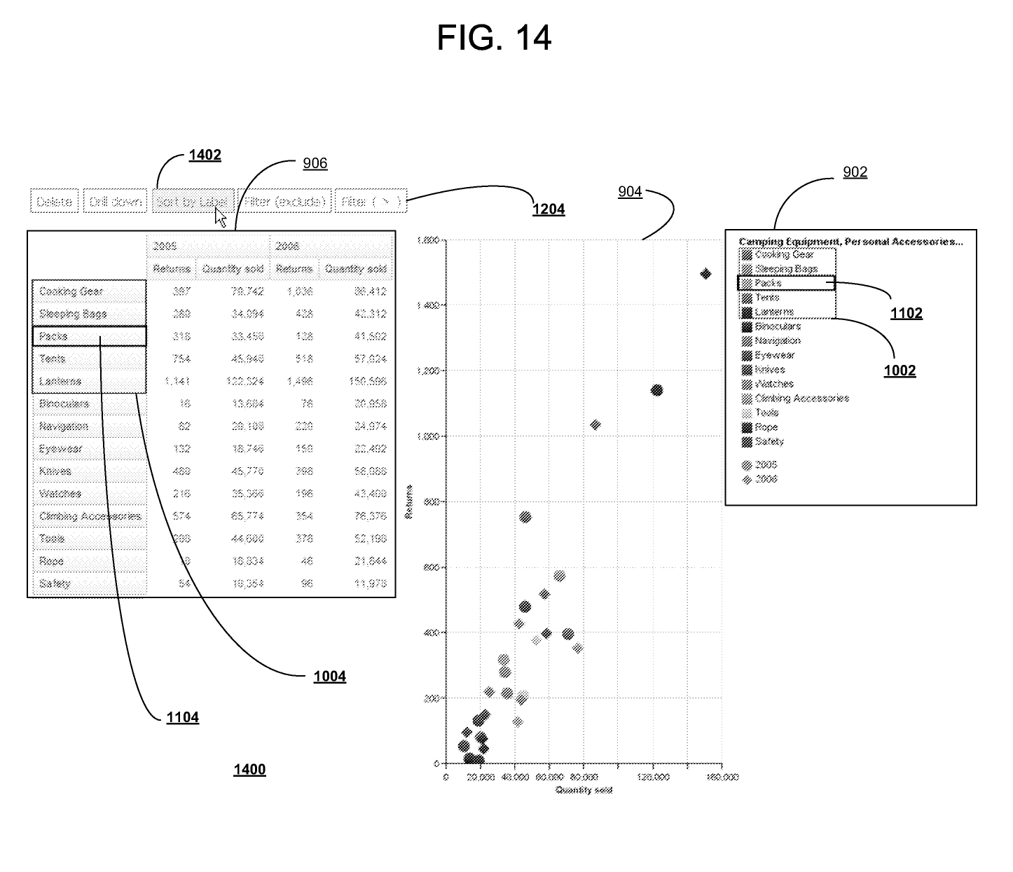

With reference to FIG. 14, a tabular representation of hovering over a Sort by Label action illustrating affected data by the action and using the process of FIG. 5, in accordance with one embodiment of the disclosure is presented. Interaction 1400 is an example of a selection of a data point of FIG. 11 with a following associated action.

Continuing previous examples, a user hovers over Sort by Label action 1402. In the visualizations, the members of set 1 as data grid 1004 associated with the user selection of Packs 1104 or packs 1102 in legend 902 are highlighted because set 1 contains the data that would be used for Sort by Label action 1402. By convention in the examples, the secondary highlighting is as a thin black line as shown around members of set 1 of data grid 1004 and items 1002.

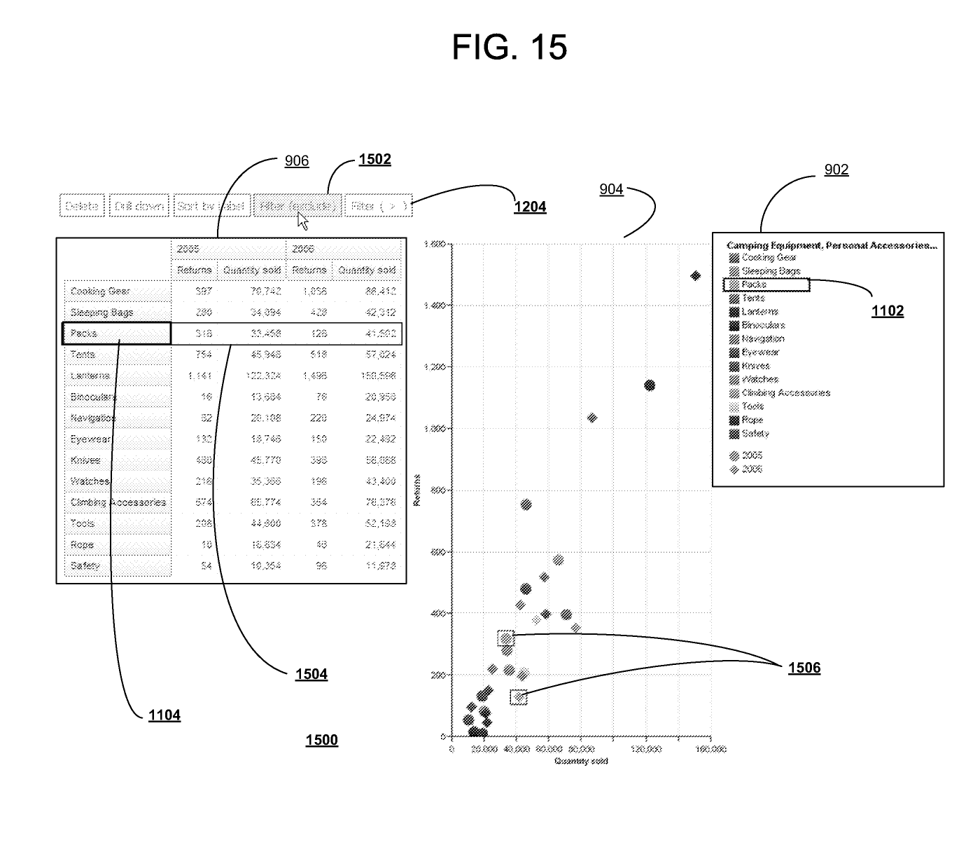

With reference to FIG. 15, a tabular representation of hovering over a Filter-exclude action illustrating affected data by the action and using the process of FIG. 5, in accordance with one embodiment of the disclosure is presented. Interaction 1500 is an example of a selection of a data point of FIG. 11 with a following associated action.

As in the previous examples, a user hovers over Filter-Exclude action 1502. Again, the user selection of Packs 1102 or Packs 1104 in legend 902 of scatter plot chart and data grid 906 respectively is shown with a thick black border. Data that will be affected by Exclude action 1502 is shown with a thin black border, as in data elements 1504 in data grid 906 and data elements 1506 of scatter plot chart 904.

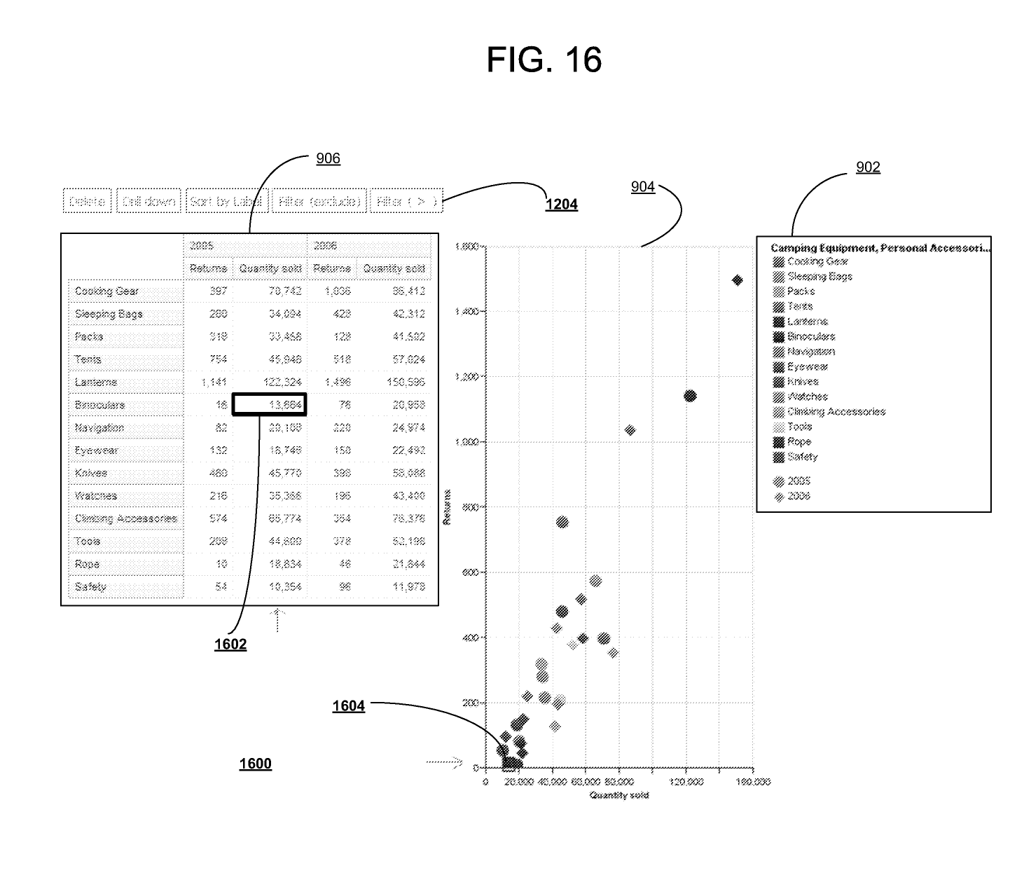

With reference to FIG. 16, a tabular representation of selecting a data point in a grid or chart using the process of FIG. 5, in accordance with one embodiment of the disclosure is presented. Selection 1600 is an example of selecting a single same data point in a data grid or a scatter plot chart using data of FIG. 9.

A user selects a data point in data grid 906, or a point scatter plot chart 904 in data visualizations of FIG. 9. In data grid 906, selection 1602 is shown as a value within a thick black line in data grid 906. The selected data in this example is a value of 13684, which represents the Quantity Sold of Binoculars in 2005.

In the scatter plot chart 904, selection 1604 is indicated as a square around the point representing an intersection of Returns and Quantity Sold for Binoculars in 2005.

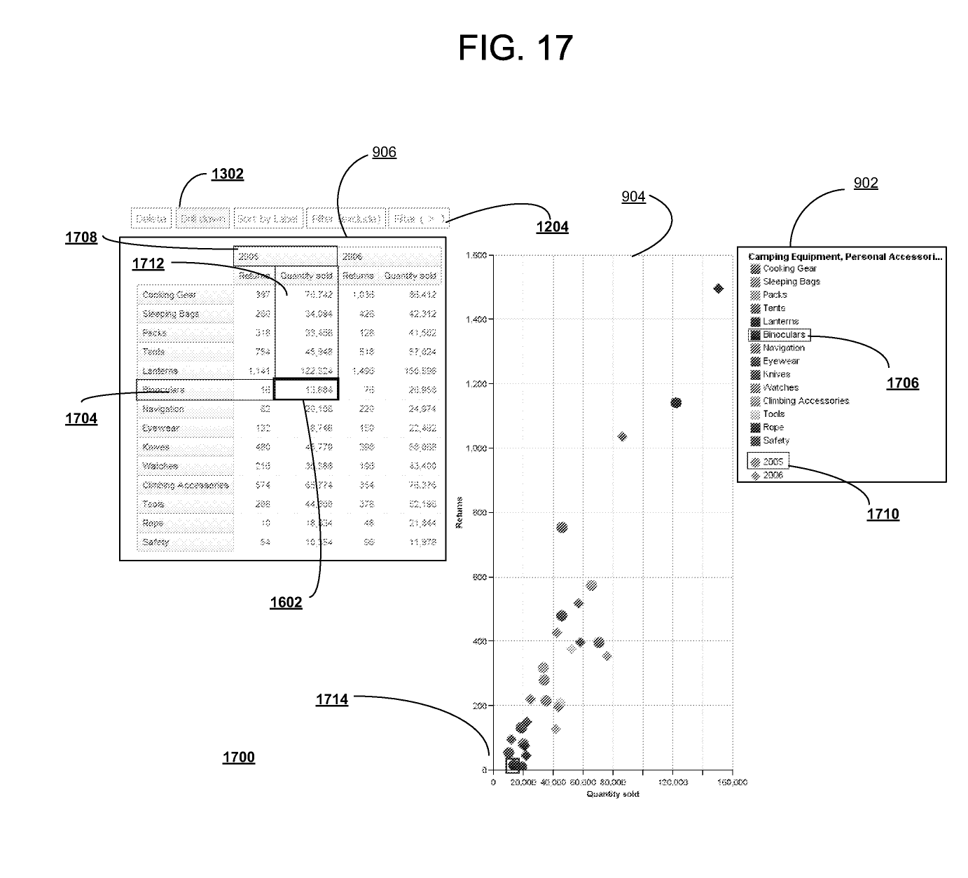

With reference to FIG. 17, a tabular representation of hovering over a Drill down action illustrating affected data by the action using the process of FIG. 5 and a data point selection of FIG. 16, in accordance with one embodiment of the disclosure is presented. Interaction 1700 is an example of a selection of a data point of FIG. 16 with a following associated action.

A user hovers over Drill Down action 1302. Using data grid 906, data elements 1708 for year 2005 potentially affected by drilldown action 1302 may be shown with a colored border while the original selection 1602 is shown with the thick black border to distinguish the related affected data from the user selected data. Data grid 1712 represents quantities of products sold in year 2005. Data grid 1704 represents the product Binoculars having been sold or returned.

Using scatter plot chart 904, the user-selected data point on the scatter plot chart is indicated with a thick colored border, intersection of Returns and Quantity Sold for Binoculars, 2005 1714 and data elements affected in the drill down are highlighted in legend 902, as Binoculars 1706, and year 2005 1710, in thin colored borders.

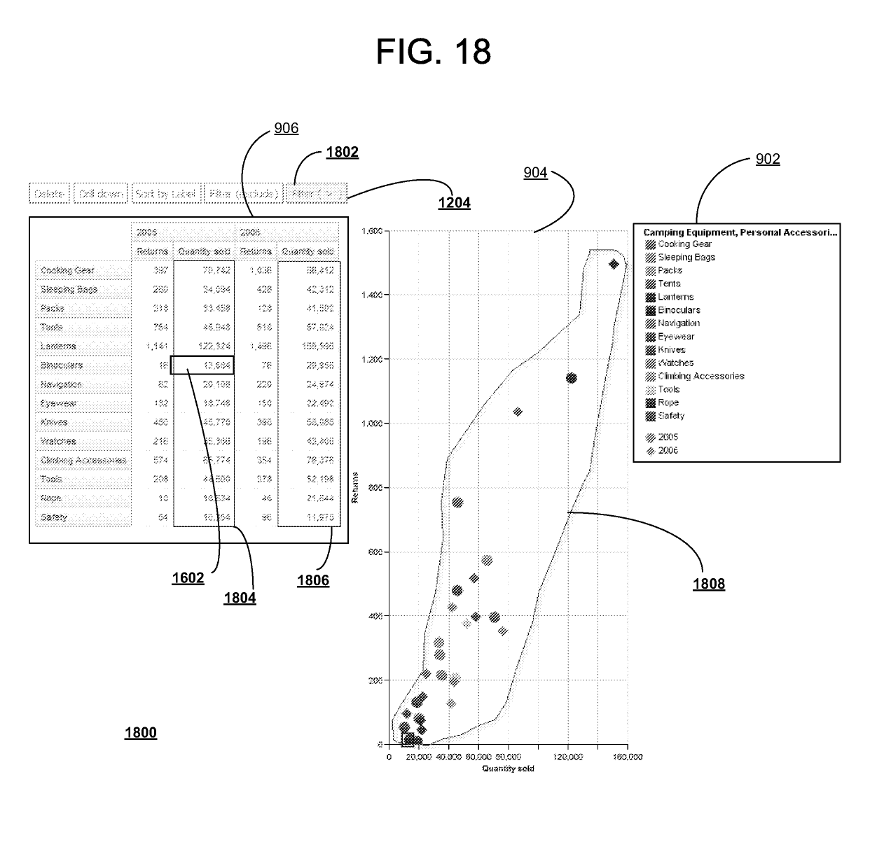

With reference to FIG. 18, a tabular representation of hovering over a Filter-greater than action illustrating affected data by the action using the process of FIG. 5 and data point selection of FIG. 16, in, in accordance with one embodiment of the disclosure is presented. Interaction 1800 is an example of a selection of a data point of FIG. 16 with a following associated action.

A user hovers over Filter action greater than 1802, specifically indicating filter values greater than a previously selected value, in this case value 1602 of 13684 from FIG. 16. In data grid 906, selection 1602 representing Quantity sold for Binoculars in 2005, having a value 13684, is shown with a thick black border. Quantity sold values in year 2005 and year 2006 are potentially affected data for the selected filter action and indicated with a thin colored border 1804 and 1806 respectively. On scatter plot chart 904, the potentially affected data of the same filter is indicated by another thin colored line. Highlighting may use a different rendering, including a different color or a different line style to differentiate selected data from potentially affected data.

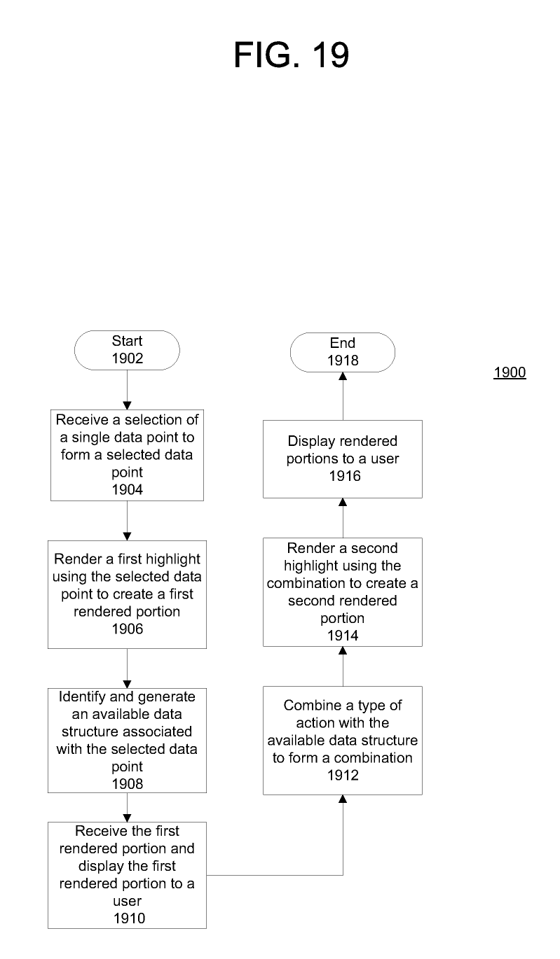

With reference to FIG. 19, a flowchart of a high level view of a process for communicating secondary selection feedback using a potential action, in accordance with an illustrative embodiment of the disclosure is presented. Process 1900 is an example of a process using system 200 of FIG. 2.

Process 1900 begins (act 1902) and receives a selection of a single data point to form a selected single data point (act 1904). The selection of a single data point typically occurs from within a visualization of a data display. For example, a data display may present a data grid, chart or other typically available data visualization from which a user may make a data selection. A visualization comprises a set of visualizations, wherein the set is one or more visualizations.

Process 1900 renders a first highlight using the selected data point to create a first rendered portion (act 1906). The first rendered portion uses a highlight to distinguish a primary selection. Highlighting may comprise a variety of techniques including color, line thickness or line style, and background color.

Process 1900 identifies and generates an available data structure associated with the selected data point (act 1908). Process 1900 receives the first rendered portion and displays the first rendered portion to a user (act 1910). Presentation of the first rendered portion confirms data items being processed to the user.

Process 1900 combines a type of action with the available data structure to form a combination (act 1912). A type of action is typically suggested by a user hovering a pointing device over one of a set of available actions in a user interface.

Process 1900 renders a second highlight using the combination to create a second rendered portion (act 1914). Process 1900 displays rendered portions to the user (act 1916) and terminates thereafter (act 1918). The display to the user provides two highlighted elements representing a primary selection and a secondary selection, wherein the secondary selection uses the combination to create the second rendered portion. The second rendered portion is distinguished from the first rendered portion visually by using highlighting.

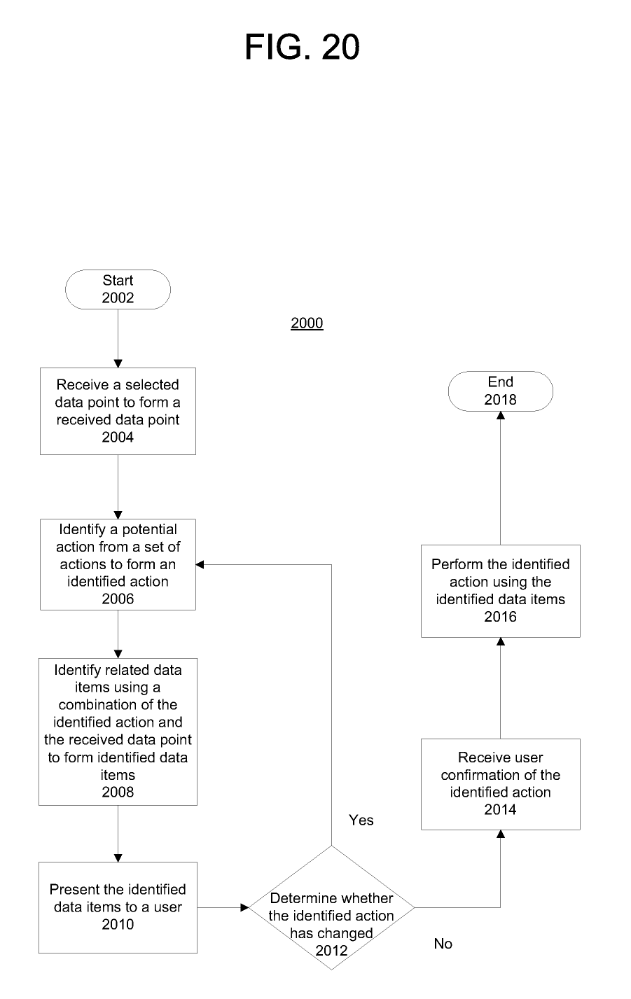

With reference to FIG. 20, a flowchart of a process for changing an action within a process for communicating secondary selection feedback using a potential action, in accordance with an illustrative embodiment of the disclosure is presented. Process 2000 is an example of a process using process 1900 of FIG. 19.

Process 2000 begins (act 2002) and receives a selected data point to form a received data point (act 2004). Process 2000 identifies a potential action from a set of actions to form an identified action (act 2006). Process 2000 identifies related data items using a combination of the identified action and the received data point to form identified data items (act 2008). Process 2000 presents the identified data items to a user (act 2010).

Process 2000 determines whether the identified action has changed (act 2012). Responsive to a determination that the identified action has changed, process 2000 loops back to perform act 2006 as before. Responsive to a determination that the identified action has not changed, process 2000 receives user confirmation of the identified action (act 2014). Process 2000 performs the identified action using the identified data items (act 2016) and terminates thereafter (act 2018).

The illustrative embodiments presented in the previous examples serve to represent a process for communicating secondary selection feedback based on action to be taken. In one embodiment a computer-implemented process provides a capability for bi-directional instructions to other objects and actions. Thus is provided a computer-implemented process for communicating secondary selection feedback using a potential action, the computer-implemented process receives a selection of a single data point to form a selected single data point, renders a first highlight using the selected data point to create a first rendered portion, identifies and generates an available data structure associated with the selected data point, displays the first rendered portion to a user, combines a type of action with the available data structure to form a combination, renders a second highlight using the combination to create a second rendered portion and displays rendered portions to the user.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

One or more aspects of the disclosure can take the form of an entirely hardware embodiment, an entirely software embodiment or an embodiment containing both hardware and software elements. In a preferred embodiment, the disclosure is implemented in software, which includes but is not limited to firmware, resident software, microcode, and other software media that may be recognized by one skilled in the art.

It is important to note that while the present disclosure has been described in the context of a fully functioning data processing system, those of ordinary skill in the art will appreciate that the processes of the present disclosure are capable of being distributed in the form of a computer readable medium of instructions and a variety of forms and that the present disclosure applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present disclosure has been presented for purposes of illustration and description, and is not intended to be exhaustive or limited to the disclosure in the form disclosed. Many modifications and variations will be apparent to those of ordinary skill in the art. The embodiment was chosen and described in order to best explain the principles of the disclosure, the practical application, and to enable others of ordinary skill in the art to understand the disclosure for various embodiments with various modifications as are suited to the particular use contemplated.

What is claimed is:

1. A computer-implemented method to communicate secondary selection feedback using a potential action, the computer-implemented process comprising:
receiving a selection of a single data point to form a selected single data point;
rendering a first highlight using the selected data point to create a first rendered portion;
identifying and generating an available data structure associated with the selected data point;
displaying the first rendered portion;
combining a type of action with the available data structure to form a combination;
rendering a second highlight using the combination to create a second rendered portion; and
displaying rendered portions.

2. The computer-implemented method of claim 1, wherein receiving a selection of a single data point to form a selected single data point further comprises:
receiving the selection of the single data point from a visualization of data, wherein the visualization comprises a set of visualizations.

3. The computer-implemented method of claim 1, wherein rendering a first highlight using the selected data point to create a first rendered portion further comprises:
selecting a highlight for a primary selection.

4. The computer-implemented method of claim 1, wherein combining a type of action with the available data structure to form a combination further comprises:
identifying a potential action from a set of potential actions in a user interface; and
identifying data items affected by the potential action related to the selected single data point.

5. The computer-implemented method of claim 1, wherein rendering a second highlight using the combination to create a second rendered portion further comprises:
selecting a highlight for a secondary selection, wherein the highlight for the secondary selection differs from the highlight selected for the primary selection.

6. The computer-implemented method of claim 1, wherein displaying rendered portions further comprises:
identifying a potential action from a set of actions to form an identified action;
determining whether the identified action has changed; and
responsive to a determination that the identified action has not changed, receiving a confirmation of the identified action; and
performing the identified action using the combination.

7. The computer-implemented method of claim 6, wherein the combination further comprises:
a potential action from a set of actions to form an identified action; and
identified related data items using the identified action and the selected single data point to form identified data items.

8. A computer program product for communicating secondary selection feedback using a potential action, the computer program product comprising:
a computer readable storage medium having computer readable program code embodied therewith, the computer readable program code comprising:
computer readable program code configured to receive a selection of a single data point to form a selected single data point;
computer readable program code configured to render a first highlight using the selected data point to create a first rendered portion;
computer readable program code configured to identify and generate an available data structure associated with the selected data point;
computer readable program code configured to display the first rendered portion;
computer readable program code configured to combine a type of action with the available data structure to form a combination;
computer readable program code configured to render a second highlight using the combination to create a second rendered portion; and
computer readable program code configured to display rendered portions.

9. The computer program product of claim 8, wherein computer readable program code configured to receive a selection of a single data point to form a selected single data point further comprises:
computer readable program code configured to receive the selection of the single data point from a visualization of data, wherein the visualization comprises a set of visualizations.

10. The computer program product of claim 8, wherein computer readable program code configured to render a first highlight using the selected data point to create a first rendered portion further comprises:
computer readable program code configured to select a highlight for a primary selection.

11. The computer program product of claim 8, wherein computer readable program code configured to combine a type of action with the available data structure to form a combination further comprises:
computer readable program code configured to identify a potential action from a set of potential actions in a user interface; and
computer readable program code configured to identify data items affected by the potential action related to the selected single data point.

12. The computer program product of claim 8, wherein computer readable program code configured to render a second highlight using the combination to create a second rendered portion further comprises:
computer readable program code configured to select a highlight for a secondary selection, wherein the highlight for the secondary selection differs from the highlight selected for the primary selection.

13. The computer program product of claim 8, wherein computer readable program code configured to display rendered portions further comprises:
computer readable program code configured to identify a potential action from a set of actions to form an identified action;
computer readable program code configured to determine whether the identified action has changed; and
computer readable program code responsive to a determination that the identified action has not changed, configured to receive a confirmation of the identified action; and
computer readable program code configured to perform the identified action using the combination.

14. The computer program product of claim 13, wherein the combination further comprises:
computer readable program code configured to select a potential action from a set of actions to form an identified action; and
computer readable program code configured to identify related data items using the identified action and the selected single data point to form identified data items.

15. An apparatus for communicating secondary selection feedback using a potential action, the apparatus comprising:
a communications fabric;
a memory connected to the communications fabric, wherein the memory contains computer readable program code;
a communications unit connected to the communications fabric;
an input/output unit connected to the communications fabric;
a display connected to the communications fabric; and
a processor unit connected to the communications fabric, wherein the processor unit executes the computer readable program code to direct the apparatus to:
receive a selection of a single data point to form a selected single data point;
render a first highlight using the selected data point to create a first rendered portion;
identify and generate an available data structure associated with the selected data point;
display the first rendered portion;
combine a type of action with the available data structure to form a combination;
render a second highlight using the combination to create a second rendered portion; and
display rendered portions.

16. The apparatus of claim 15, wherein the processor unit executes the computer readable program code to:
receive the selection of the single data point from a visualization of data, wherein the visualization comprises a set of visualizations.

17. The apparatus of claim 15, wherein the processor unit executes the computer readable program code:
select a highlight for a primary selection.

18. The apparatus of claim 15, wherein the processor unit executes the computer readable program code to:
identify a potential action from a set of potential actions in a user interface; and
identify data items affected by the potential action related to the selected single data point.

19. The apparatus of claim 15, wherein the processor unit executes the computer readable program code to:
select a highlight for a secondary selection, wherein the highlight for the secondary selection differs from the highlight selected for the primary selection.

20. The apparatus of claim 15, wherein the processor unit executes the computer readable program code to:
identify a potential action from a set of actions to form an identified action;
determine whether the identified action has changed; and
responsive to a determination that the identified action has not changed, receive a confirmation of the identified action; and
perform the identified action using the combination, wherein the combination further comprises a potential action from a set of actions to form an identified action and identified related data items using the identified action and the selected single data point to form identified data items.
